(19) United States
(12) Patent Application Publication
(10) Pub. No.: US 2025/0335818 A1
(43) Pub. Date: Oct. 30, 2025

(54) STREAMING MACHINE LEARNING MODEL SELECTION

(71) Applicant: Intuit, Inc., Mountain View, CA (US)

(72) Inventors: Vigith MAURICE, Portland, OR (US); Amit KALAMKAR, Fremont, CA (US)

(21) Appl. No.: 18/651,549

(22) Filed: Apr. 30, 2024

(51) Int. Cl. G06N 20/00

(52) U.S. Cl. CPC G06N 20/00

(57) ABSTRACT

Certain aspects of the disclosure pertain to machine learning evaluation and selection in a streaming environment. A machine learning model can generate inferences based on real time streaming data. A plurality of machine learning models can be available for a particular domain or task. Performance of the plurality of machine learning models can be continuously evaluated. Based on evaluation results, at least one of the plurality of machine learning models can be selected to provide output. For example, the streaming data can be routed to a selected machine learning model. Further, a poor-performing model, as determined based on evaluation results, can be fine-tuned based on real time data to improve performance.

### FIELD

Aspects of the subject disclosure relate to artificial intelligence and, more specifically, continuous evaluation and selection of machine learning models.

### DESCRIPTION OF RELATED ART

Machine learning typically revolves around static batch processing of fixed data, which involves collecting and processing data offline in discrete batches. Data is collected, grouped into fixed-size batches at a predefined interval, and saved. Subsequently, the batched data can be retrieved and utilized to train a machine learning model to make predictions concerning unseen data. However, batch processing may require significant computational resources and not scale efficiently for large volumes of data. Further, such an approach is not conducive to rapidly changing data streams as the batch data does not provide timely insights or adaptability to evolving conditions. The availability of continuously streaming data and demand for real-time data analysis and decision-making underscores the need for a streaming approach to machine learning.

### SUMMARY

According to one aspect, a machine learning model evaluation and selection method comprises sampling streaming input in a streaming platform producing sampled input data, routing the sampled input data to two or more machine learning models, evaluating performance of each of the two or more machine learning models based on the sampled input data, identifying a select machine learning model from the two or more machine learning models based on the performance of each of the two or more machine learning models, and configuring the streaming platform to employ the select machine learning model for inferencing.

According to another aspect, a method includes receiving operational data regarding a deployed application, adding the operational data to an input stream, sampling the input stream at a sampling frequency to produce sampled input data, routing the sampled input data to two or more large language models, evaluating each of the two or more large language models, identifying a select large language model from the two or more large language models based on performance of each large language model, and configuring a streaming platform to employ the select large language model for inferencing.

Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects of this disclosure.

### DESCRIPTION OF THE DRAWINGS

The appended figures depict certain aspects and are, therefore, not to be considered limiting of the scope of this disclosure.

FIG. 1 is a block diagram of a high-level overview of an example implementation of machine learning model selection.

FIG. 2 is a block diagram of an example model selection system.

FIG. 3 is a flow chart diagram of an example method of machine learning model selection.

FIG. 4 is a flow chart diagram of an example method of machine learning model evaluation.

FIG. 5 is a block diagram of an operating environment within which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for continuously evaluating and selecting machine learning models for streaming inferencing.

A machine learning model is typically trained on a fixed dataset during development. A trained model can then be deployed to perform inference tasks on previously unseen data. The static nature of the data sets means the model's predictions or inferences are based solely on information in the original data set and do not account for any new or incoming data. Over time, a machine learning model's performance can degrade if the underlying data distribution changes or drifts since the machine learning model may no longer capture patterns and relationships in the current data. Accordingly, a machine learning model can be updated or fine-tuned periodically to respond to changes in a data distribution or improve predictive accuracy.

A/B testing can be employed with respect to an initial deployment or replacement of a currently deployed machine learning model. A/B testing involves comparing two variants based on specific metrics to determine which performs better. For example, two different versions of a machine learning model may be considered for initial deployment, or a current production version can be compared against a new, updated version of the machine learning model. Different versions of the machine learning model can be provided with real-world data, and their predictions or inferences can be compared to determine which version performs best. The best-performing machine learning model can subsequently be deployed initially or replaced with a current version.

However, several technical problems are associated with conventional machine learning and A/B testing. First, training a model on a fixed data set results in model accuracy challenges over time when data distributions shift and requires continuous monitoring and human intervention to generate and deploy an updated model. A/B testing is also static and does not enable prompt identification and compensation for subtle drifts in model performance over time. Consequently, machine learning performance is captured at a single point in time. After deployment, manual intervention is required to trigger re-testing based on any change affecting model performance or on a periodic schedule.

Aspects described herein relate to streaming machine learning model evaluation and selection and provide a technical solution to at least the aforementioned technical problems. In particular, the aspects include continuous model evaluation based on sampling of one or more live or real time input data streams. Given the sampled input data, the performance (e.g., accuracy, resource utilization) of two or more machine learning models can be determined and compared continuously to select the best-performing machine learning model. Further, a machine learning model can change dynamically at runtime by routing input data to the best-performing model without halting processing to deploy a different machine learning model. Feedback loops can also dynamically adjust a sampling frequency in real time to drive ongoing refinement of model evaluation and selection. Maintaining persistent evaluation and selection optimized with streaming data analysis ensures high-quality inferences even as a data distribution evolves unpredictably. In contrast to traditional static A/B testing, a full production monitoring solution is disclosed through a self-adjusted evaluation cycle that addresses technical problems, such as unnoticed drifts in underlying data characteristics and maintaining performance for dynamic streaming applications through automated long-term evaluation of machine learning models.

Further aspects relate to custom machine learning models that are specifically trained or fine-tuned for particular domains, data types, or use cases expected. These custom machine learning models can exploit transfer learning and further training from a large industry-standard model, such as OpenAI®, using customized data sets. The fine-tuning process enables custom machine learning models to potentially outperform large, general off-the-shelf models in their intended streaming inference tasks, as they are tailored to specific data. By specializing machine learning models for real time inputs and tasks, technical benefits are achieved, including improved accuracy for specific use cases compared to general models and more efficient resource utilization due to smaller model size. Continuous evaluation and selection of machine learning models, including custom machine learning models, ensures that any degradation in model performance is promptly and automatically addressed to maintain high-quality inferences.

### Example Implementation of Machine Learning Model Selection

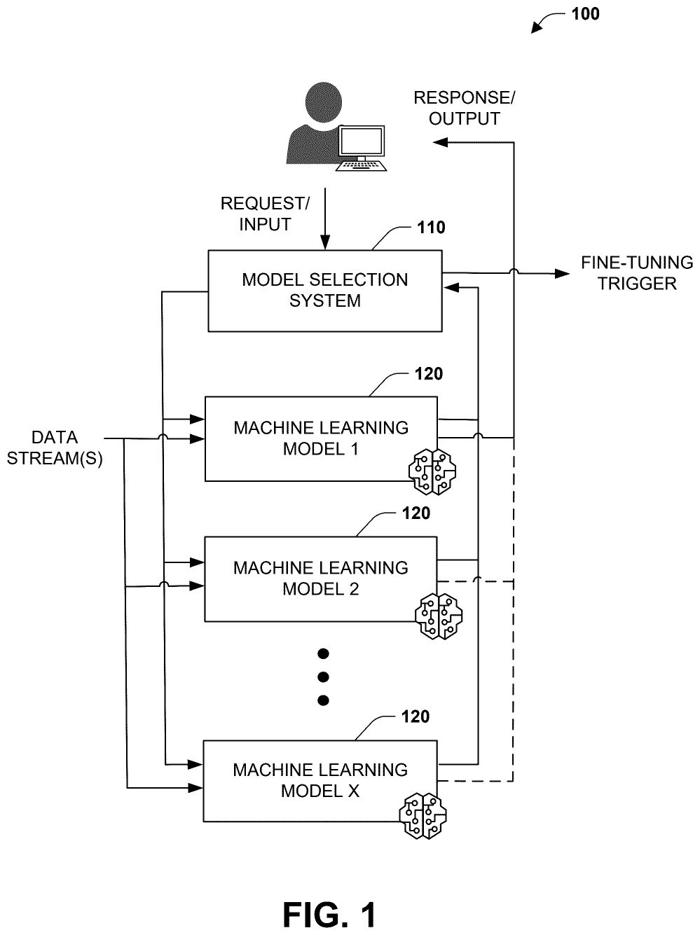

FIG. 1 depicts a high-level overview of an example implementation 100 of aspects associated with machine learning model selection in a streaming platform. The implementation 100 includes a model selection system 110 and a plurality of machine learning models 120.

The model selection system 110 is configured to select and activate at least one of the plurality of machine learning models 120 to process streaming inference tasks. In accordance with one embodiment, a request can be received from a user by way of a computing device (e.g., tablet, desktop computer, terminal, laptop computer, smartphone). The request can be routed to at least one of the plurality of machine learning models 120 and the output of the at least one of the plurality of machine learning models 120 can be transmitted back to the computing device as a response to the request.

For example, a user can request an explanation of an issue that caused an application or system rollback to a previous state. The request can be routed to a machine learning model 120, which, based on streaming operational data, can generate a text explanation of the cause of the rollback that is returned to the user as a response. In addition, the machine learning model 120 can optionally generate a likely root cause and return text specifying the root cause as part of the response. For example, a text explanation or summary can be “There are 676 information logs indicating that users were successfully logged in and requests were served successfully. The Kubernetes event shows that the container was terminated due to an OOMKilled.” The potential root cause can be “The container was terminated due to an out-of-memory (OOM) error, which may have caused the runtime error in the error log. Too many Redis connections opened may indicate an underlying issue with the connection that caused the runtime error.”

In accordance with another embodiment, the inference task can be automatically triggered rather than requiring a request. For example, in the previous example, detecting an anomaly such as an application or system rollback may automatically trigger generation of the text summary and prediction of the potential root cause.

In yet another embodiment, the inference task can be continual or perpetual. Consider an inference task corresponding to prediction or classification, such as a financial fraud detection application. In this situation, a machine learning model can be trained to classify a stream of transactions as fraudulent or not fraudulent. In this situation, the prediction can be performed without a request issued from an individual other than perhaps to initiate fraud detection. In this instance, the output can be one or more fraudulent transactions.

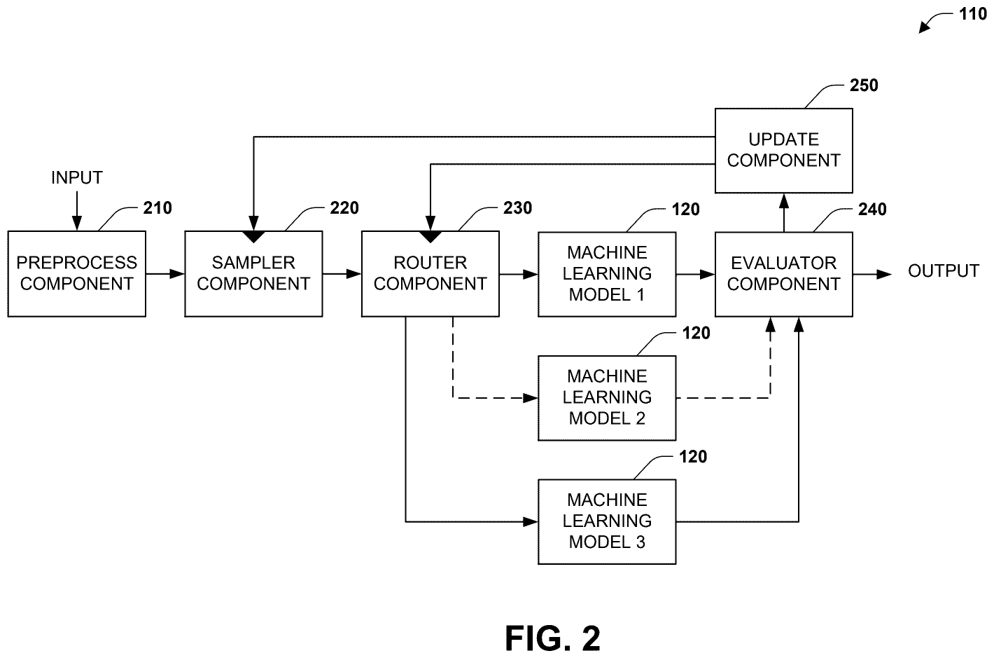

As described in further detail in FIG. 2, the model selection system 110 can evaluate the plurality of machine learning models 120. Based on the evaluation result, the model selection system 110 can select and activate one of the plurality of machine learning models for an inferencing task. Evaluation can involve comparing the performance of the plurality of machine learning models 120. In one instance, performance can refer to accuracy. Accuracy can correspond to the ratio of correctly classified instances to the total number of instances. For regression tasks, accuracy can be computed using mean square error, for example, to measure how close data points are to a regression line. For text generation, accuracy can pertain to evaluating the quality, coherence, relevance, and specificity of the text. Depending on the application, various mechanisms can capture performance metrics, such as human evaluation, automatic evaluation metrics, or both. Further, evaluation can pertain to the size of a machine learning model and computing resources utilized to execute the machine learning model. Accordingly, a small machine learning model that efficiently uses computing resources may be better than a large machine learning model that utilizes significant resources for a particular use case. The size of a machine learning model can be determined based on resource requirements, such as central processing unit, graphics processing unit, and memory requirements. Further, the size and resource utilization can be dictated by the number of parameters the machine learning model is trained on, such that the larger the number of parameters the bigger the size. In one instance, a combination of accuracy and size can be considered when assessing machine learning model performance.

The plurality of machine learning models 120 includes machine learning model 1, machine learning model 2, and machine learning model X (wherein X is an integer greater than 2). In other words, substantially any number of machine learning models 120 can be present and available for use. In accordance with one embodiment, the machine learning models 120 can correspond to large language models. Further, the machine learning models 120 can vary by type. In one instance, a machine learning model can correspond to a general off-the-shelf language model such as OpenAI®. Alternatively, the machine learning model 120 can correspond to a custom machine learning model tailored to a particular domain or set of tasks. A custom machine learning model can be generated based on domain-specific training data, yielding a smaller and equally or more accurate machine learning model for the domain than a larger and more general machine learning model.

Further, the machine learning models 120 can perform inferencing over one or more real time data streams. Continuing with the above example regarding a text explanation of the cause of the rollback, the machine learning models 120 can receive one or more operational data streams regarding application or container state, health status, and events, for instance. Each of the machine learning models 120 can receive the data streams. However, in one embodiment, the output of solely one machine learning model can be provided as a response. As shown, the machine learning model 1 is selected to generate a response to the request, while the others are not, as illustrated by the dashed lines. In accordance with one embodiment, the machine learning model 1 can correspond to a general and large language model such as OpenAI®, and machine learning model 2 can correspond to a custom machine learning model. Over time, the custom machine learning model may surpass the general machine learning model in terms of performance through fine-tuning. In that instance, the custom machine learning model can be selected and activated to respond to requests, for example, and the general machine learning model can be deactivated. In another embodiment, output from multiple machine learning models can be provided in response to a request. Further, human feedback can be solicited regarding the relative quality of each response from multiple machine learning models to aid in evaluation.

Output generated by the plurality of machine learning models 120 can also be returned to the model selection system 110. The output from multiple machine learning models can be utilized for evaluation as well as training or fine-tuning. As per evaluation, the outputs can be compared to determine which model is the most accurate, for example. The accuracy can then be used to select the top-performing model. With respect to training, the outputs and the accuracy could be used as training data to retrain or fine-tune models, if needed, to improve model accuracy over time based on the continuous evaluation results.

### Example System of Model Selection

FIG. 2 illustrates a block diagram of an example implementation of the model selection system 110 briefly described in FIG. 1. In the depicted example, the model selection system 110 includes preprocess component 210, sampler component 220, router component 230, and evaluator component 240, and update component 250 in addition to three machine learning models 120. The preprocess component 210, sampler component 220, router component 230, evaluator component 240, and update component 250 can be implemented by at least one processor coupled to at least one memory that stores instructions that, when executed by the at least one processor, cause the processor to perform the functionality of each component when executed. Consequently, a computing device can be configured as a special-purpose device or appliance that implements the functionality of the model selection system 110. Further, all or portions of the model selection system 110 can be distributed across computing devices or made accessible through a network service.

The preprocess component 210 is configured to receive one or more data streams from one or more data sources and initiate initial processing of the one or more data streams. In accordance with one embodiment, the preprocess component 210 can perform aggregation and deduplication. With respect to aggregation, data from multiple streams can be combined into a single unified stream. Aggregation allows different but related data elements (e.g., events, logs, health status, container state) to be evaluated together by machine learning models. Such consolidation and joint analysis improve performance efficiency over separate data analysis. As per deduplication, duplicate or redundant data in a stream, such as the unified stream, can be identified and removed. Deduplication reduces computational overhead by eliminating duplicate data and provides a cleaner input for machine learning models by removing noise from repetitive data. The preprocess component 210 can provide additional functionality, including, but not limited to, data cleaning (e.g., providing missing values, addressing inconsistencies), anonymization (e.g., removing identity attributes for privacy), and filtering (e.g., removing unrelated data to focus on a particular domain). At a high level, the preprocess component 210 prepares streaming data for optimal machine learning model evaluation and selection.

The sampler component 220 is configured to select a subset of streaming data and output samples to the router component 230. More specifically, the sampler component 220 receives aggregated streaming data from a unified stream. The sampler component 220 can apply a sampling frequency to select a portion of the data. The sampler component 220 improves processing efficiency by selecting a representative sample of data rather than all the data, reducing computational overhead. Further, the sampler component 220 aids continuous evaluation based on live data without disrupting streaming and inference. As further described herein, the sampler component 220 can also accept side input, for example, to adjust the sampling frequency. A side input is a communication mechanism that enables components to receive messages at runtime and potentially change runtime processing without halting or disrupting processing.

The router component 230 is configured to route streaming data samples to at least one machine learning model 120 through a processing path that includes at least one machine learning model 120. In accordance with one embodiment, streaming data samples can be routed to a top-performing machine learning model for inference generation. For example, machine learning model 1 can correspond to the top-performing machine learning model. However, the router component 230 can also route streaming data samples through other machine learning models 120, such as machine learning model 2 and machine learning model 3. In one instance, the router component 230 can stop routing streaming data samples to a poor-performing machine learning model, effectively decommissioning the poor-performing machine learning model. As depicted, dashed lines indicate that the router component stopped routing data samples to machine learning model 2. The router component 230 thus enables requests to be directed to the most accurate model based on continuous evaluation, improving overall inference quality. Similar to the sampler component 220, the router component 230 accepts side input. Here, the router component 230 can receive information about which models to route traffic to based on evaluation results, for example. Accordingly, responsiveness to changes in machine learning model performance can be addressed dynamically without disrupting or halting processing or inference.

The evaluator component 240 is configured to evaluate machine learning model performance continuously. The evaluator component 240 can receive output generated by a plurality of machine learning models 120 for the sampled streaming data. The output can be accessed across one or more evaluation metrics, such as accuracy and relevance. The evaluator component 240 can compute performance scores over time in one embodiment that reflect a machine learning model's quality relative to generating inferences. In one instance, machine learning model size and resource utilization can be considered part of the evaluation, such that a small model is preferred over a large model when the quality is comparable or within a threshold of each other. In this manner, a small model reduces storage and computational costs with similar inference quality. Further, a large machine learning model such as OpenAI® can be utilized as a baseline to compare the performance of smaller custom machine learning models targeting a specific domain or task. Stated differently, a streaming inference process or platform can be continuously evaluated, in one instance, by using an industry-standard machine learning model as a baseline, to enable automatic real time (or near real-time) adjustments to improve inference quality and reduce cost (e.g., latency, size, processing resources required).

In one instance, performance scores can be compared with a threshold for triggering fine-tuning. Suppose the performance score of a machine learning model 120 satisfies an underperformance threshold or fails to satisfy a performance threshold. In that case, a separate offline process can be triggered to fine-tune the machine learning model 120. In one embodiment, the machine learning model 120 can be fine-tuned with a data set that includes data collected, enriched, and annotated in real time from data streams, for example, by the preprocess component 210. Furthermore, the performance scores can be provided to the update component 250.

In particular, aspects described herein relate to a streaming platform that enables data to be collected, cleansed, and enriched in real time as it is received. In one instance, collected and cleansed data can be provided as input to a machine-learning model, and the output can be a tag or label for the input data, thereby enriching the data. In other words, the machine-learning model can provide pseudo labels. These pseudo-labels can be stored and subsequently retrieved and utilized to fine-tune a target machine learning model.

The update component 250 is configured to receive input from the evaluator component 240 and communicate with the sampler component 220 and the router component 230 through side input. The update component 250 can adjust sampling frequency through side input with the sampler component 220. If results produced by the evaluator component 240 indicate a change in the performance of a machine learning model, then the update component 250 can instruct the sampler component 220 to change the sampling frequency.

For example, suppose a machine learning model begins underperforming on certain data types. In that case, the sampling frequency can be increased to gather more evaluation data to assist in identifying issues and model improvement. For machine learning models that consistently perform well, the sampling frequency can be decreased to reduce the computational overhead associated with evaluations. When a machine learning model is newly introduced, sampling can be temporarily increased to aid in the expeditious validation of model performance. Overall, the update component 250 can aid in dynamically adjusting the sampling frequency based on real-time model performance to efficiently focus evaluation on areas needing refinement while maintaining responsiveness.

The update component 250 can also aid in updating routing through side input with the router component 230. Routing can be updated based on the relative performance of a plurality of machine learning models produced by the evaluator component 240. For example, after each evaluation cycle, the evaluator component 240 can determine the best-performing machine learning model and signal this determination to the update component 250. The update component 250 can then communicate with the router component 230 to dynamically adjust to prioritize routing new inputs to the best-performing machine learning model. Over multiple evaluation cycles, a poor-performing machine learning model can be gradually deprioritized or removed from consideration. Responding to real-time evaluation feedback can optimize routing to production conditions without periodic redeployment interruptions.

As an example, consider a situation in which a user submits a question to a machine learning model, such as “How do I file my taxes is my spouse is in a different state?” The preprocess component 210 can analyze the input and identify the question as a tax question with an annotation that indicates “out-of-state complex filing.” The sampler component 220 can see that this relates to tax. Further, during peak tax times as controlled by the update component 250 via side input, the sampling frequency can be adjusted to one hundred percent. The router component 230 can identify the question as related to tax and out-of-state filing along with the input question and send such information to a machine learning model, such as machine learning model 1, that is trained for out-of-state and other complex tax questions. The machine learning model can parse the request and generate a result, such as the steps to follow to file correctly. The evaluator component 240 can initially mark the result as of an unknown quality (e.g., query-id: xyz quality: unknown). The evaluator component 240 can wait for feedback after a user executes the steps returned by the model, which can be out-of-band, although may not be required in other scenarios. The evaluator component 240 can later fetch the feedback and update itself to know how the machine learning model performed so that the next time something similar happens it will know how different or similar the results from the machine learning model are for a like question. The update component can broadcast state changes to other components to dynamically change behavior, for instance based on whether it is peak or non-peak tax season and the quality of a machine learning model, among other things.

### Example Methods of Machine Learning Model Selection

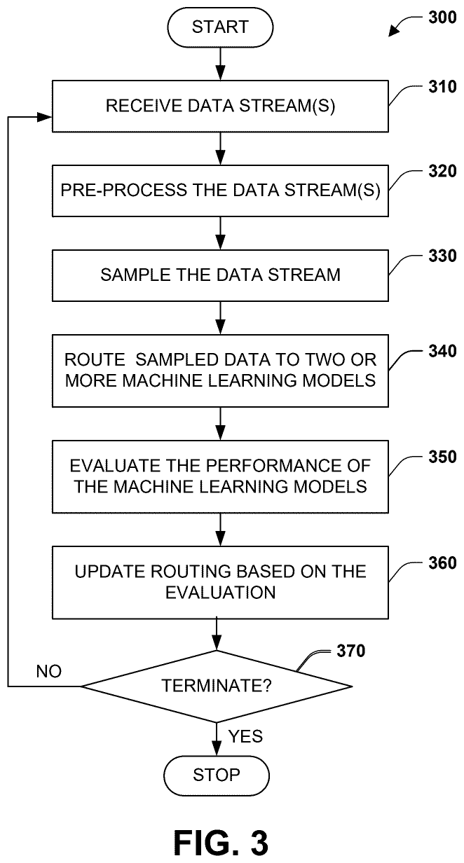

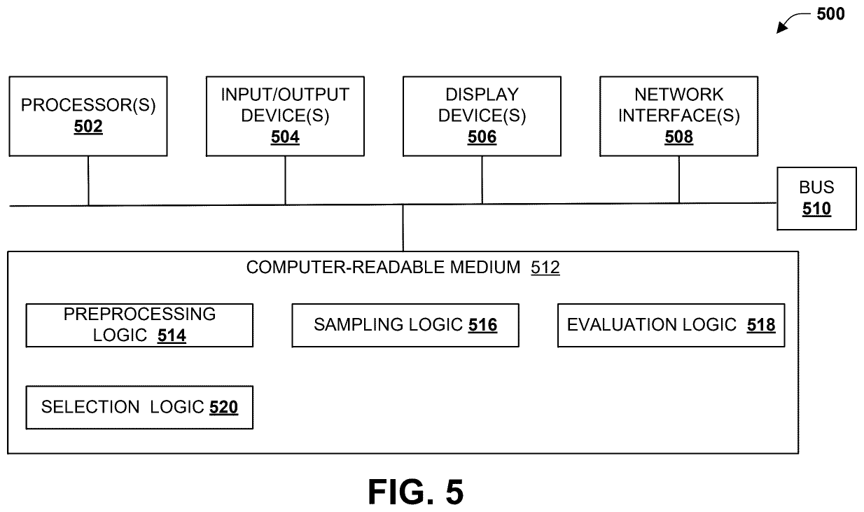

FIG. 3 depicts an example method 300 of streaming machine learning model selection. In one aspect, method 300 can be implemented by the model selection system 110 FIGS. 1 and 2 and processing apparatus of FIG. 5.

Method 300 starts at block 310 with receiving one or more data streams. A data stream is a continuous real time flow of information from a source. In accordance with one embodiment, the data stream can comprise operational data, such as logs and events regarding application or container state and health status, for instance. In some instances, particular data can be provided in separate data streams from separate sources, such as Kubernetes or metric systems.

Method 300 then proceeds to block 320 with preprocessing the one or more data streams received at block 310. In accordance with one embodiment, preprocessing can include aggregation and deduplication. With respect to aggregation, data from multiple streams can be combined into a single unified stream. For example, operational data from different streams can be combined into a single data stream comprising operational data from the different streams. As per deduplication, duplicate or redundant data in a stream, such as the unified stream, can be identified and removed. For instance, if the unified stream of operational data includes duplicate events, one of the events can be removed. Preprocessing data is not limited to aggregation and deduplication. Other preprocess operations can include but are not limited to data cleaning (e.g., providing missing values, addressing inconsistencies), anonymization (e.g., removing identity attributes for privacy), and filtering (e.g., removing unrelated data to focus on a particular domain). At a high level, preprocessing prepares streaming data for efficient machine learning model evaluation and selection.

Method 300 continues next to block 330 with sampling the data stream. Sampling comprises selecting a subset of streaming data. More specifically, sampling can comprise receiving aggregated streaming data from a unified stream and selecting a portion of the data from the unified stream based on a sampling frequency. The sampling frequency refers to the rate at which a portion of incoming streaming data is selected. In other words, sampling frequency captures the percentage or number of data elements selected from the full set. Sampling improves process efficiency by selecting a representative sample of data rather than all the data, reducing computational overhead.

Method 300 proceeds to block 340, routing sampled data to two or more machine learning models. Two or more machine learning models can be candidates for inference generation. In accordance with one embodiment, a general large language mode such as OpenAI can correspond to a first machine learning model. A second machine learning model can correspond to a custom language model targeted for a particular domain or task. Sampled data from a stream can be routed to the two or more machine learning models for inferencing.

Method 300 continues next to block 350, where the performance of the two or more machine learning models is evaluated. Machine learning models can be evaluated based on one or more metrics, such as accuracy and relevance. Performance scores that reflect a machine learning model's quality can be computed over time relative to generating inferences. In one instance, machine learning model size and resource utilization can be considered part of the evaluation and score, such that a small model is preferred over a large model when accuracy is comparable or within a threshold. Further, an industry-standard machine learning model, such as OpenAI, can be utilized as a baseline to compare the performance of smaller machine learning models targeting a specific domain or task.

Method 300 next proceeds to block 360, with updating routing based on an evaluation result. The evaluation result serves to identify the machine learning model that is currently producing the highest quality inferences. The routing can be updated dynamically to prioritize routing real-time data and user requests to the top-performing machine learning model. The routing can be updated by configuring a router through side input to prioritize routing to the top-performing machine learning model. In one embodiment, an update can be made if there is a change in the model deemed the top-performing machine learning model for efficient use of computational resources.

Method 300 next continues at block 370, where a determination is made as to whether or not to terminate processing. Continuous processing is desired to perform model evaluation as part of a streaming service or platform. However, there can be scenarios when termination is desired or required. For example, planned termination can be utilized for maintenance, upgrades, or redeployment. In another instance, if machine learning models degrade to the point that they no longer provide accurate inferences, processing can be shut down to avoid poor user experiences and address any issues. If processing is not to be terminated (“NO”), the method 300 loops back to block 310, continuing to receive one more data streams. If processing is to terminate (“YES”), the method 300 terminates.

The method 300 dynamically evaluates and updates machine learning models by continuously monitoring their performance on streaming data inputs. Such a dynamic approach enables issues to be identified and proactively addressed before significant degradation occurs, thereby improving model inferencing. Further, in one instance, the method 300 can enable updating routing to a smaller model that utilizes less computing resources (e.g., CPU, memory, storage) while preserving inferencing quality.

Note that FIG. 3 is just one example of a method, and other methods including fewer, additional, or alternative steps are possible consistent with this disclosure.

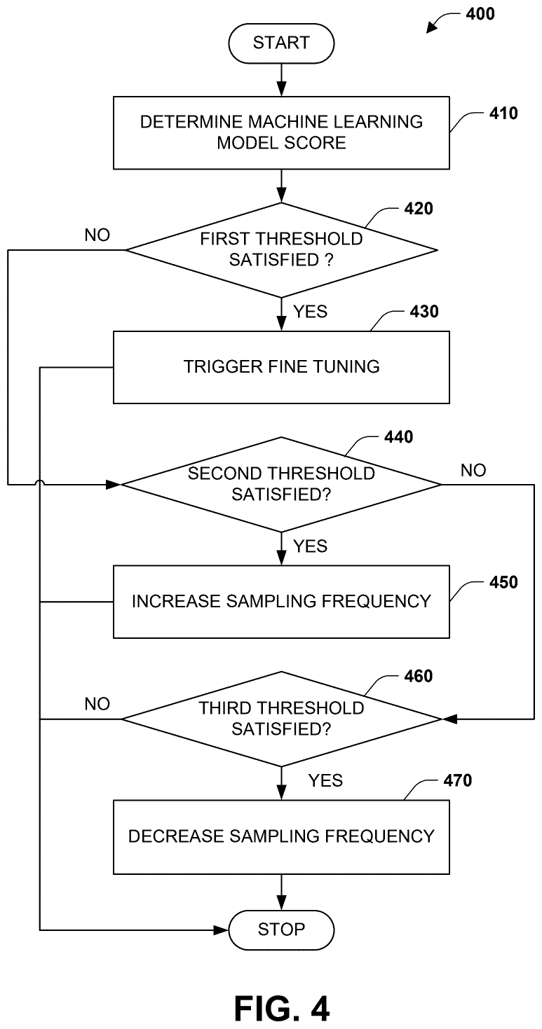

FIG. 4 depicts an example method 400 of machine learning model evaluation. In one aspect, method 400 can be implemented by the model selection system 110 of FIGS. 1 and 2, including the evaluator component 240 of FIG. 2 and the processing apparatus of FIG. 5.

Method 400 starts at block 410 with determining a score associated with a machine learning model. The score can be a quantitative metric that captures the overall quality and performance of the machine learning model with respect to generating inferences. Quantitative metrics can include accuracy as well as metrics beyond accuracy, such as recall and precision, among others. As previously described, accuracy measures the correctness of machine learning model output or inferences. Recall measures output completeness (e.g., how often positive instances are identified from all actual positive instances in a sample), and precision focuses on correctness (e.g., how often a positive class is predicted with respect to the total number of predictions (e.g., true and false)). For example, the score can capture and summarize a model's predictive accuracy (e.g., how often inferences were correct) and relevance (e.g., how pertinent the responses were to the requests). The score can objectively capture a model's strengths and weaknesses and aid in identifying a top-performing model (e.g., highest scoring model).

The method 400 continues at block 410 with determining whether or not the score satisfies a first threshold. In accordance with one embodiment, the first threshold can correspond to a low bound on performance. In this instance, satisfying the threshold can correspond to a score less than or equal to a low-bound threshold. The threshold can capture situations in which model performance degraded significantly or new input features or domains exist that the model was not trained on and performs poorly. If the first threshold is satisfied (“YES”), the method 400 continues at block 430. If the first threshold is not satisfied (“NO”), the method 400 proceeds to block 440.

At block 430, fine-tuning of the machine learning model is triggered. In this instance, the machine learning model can be deactivated, decommissioned, or deleted from further consideration. The fine-tuning process can be performed offline and outside the streaming process in accordance with one embodiment. Further, the machine learning model can be fine-tuned utilizing inputs and outputs produced by another model, such as an industry-standard model like OpenAI. The method 400 can subsequently terminated after triggering fine-tuning.

At block 440, a determination is made as to whether or not the score satisfies a second threshold. The second threshold can capture poor performance, but performance better than that associated with the first threshold. In accordance with one embodiment, satisfying the threshold can correspond to a score greater than the first threshold but less than or equal to the second threshold. For example, a machine learning model can underperform in a small and isolated manner concerning a specific data type. If the second threshold is satisfied (“YES”), the method 400 proceeds to block 450. If the second threshold is not satisfied (“NO”), the method 400 continues at block 460.

At block 450, the method 400 increases the sampling frequency. Sampling frequency refers to the rate at which a portion of incoming streaming data is selected. Increasing the sampling rate corresponds to an increase in the rate or number of data elements selected from a full set of data elements. Increasing the sampling frequency enables further insight to be gained through extra samples before committing resources to fine-tuning based on early signs of potential issues. After increasing the sampling frequency, the method 400 terminates.

At block 460, the method 400 comprises determining whether or not the score satisfies the third threshold. Unlike the first and second thresholds that relate to poor performance, the third threshold concerns high performance. In accordance with one embodiment, satisfying the threshold can correspond to a performance score greater than or equal to the second threshold. For example, a machine learning model may outperform others by a wide margin based on its score. If the score satisfies the third threshold (“YES”), the method 400 continues at block 470. If the score does not satisfy the third threshold (“NO”), the method 400 terminates.

The method 400 proceeds at block 470 with decreasing the sampling frequency. Decreasing the sampling frequency corresponds to a decrease in the rate or number of data elements selected from a full set of data elements. Decreasing the sampling frequency enables performance optimization by freeing computing resources for high-performing machine-learning models through less frequent sampling.

The method 400 provides real time feedback loops that allow issues to be promptly detected and addressed. For example, data drift can result in poor performance of a machine learning model. Continuous monitoring and evaluation can promptly detect and respond to a data drift by triggering fine-tuning rather than being delayed until a later static evaluation window. Further, the evaluation process can self-optimize by adjusting sampling or other tuning based on up-to-date performance signals. Overall, the method 400 can ensure that the most effective models and efficient evaluation methods are employed and optimized for current real-world data through an ongoing adjustment process.

Note that FIG. 4 is just one example of a method, and other methods including fewer, additional, or alternative steps are possible consistent with this disclosure.

### Example Processing System for Machine Learning Model Selection

FIG. 5 depicts an example processing system 500 configured to perform various aspects described herein, including, for example, methods as described above with respect to FIGS. 3 and 4.

Processing system 500 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In the depicted example, processing system 500 includes one or more processors 502, one or more input/output devices 504, one or more display devices 506, and one or more network interfaces 508 through which processing system 500 is connected to one or more networks (e.g., a local network, an intranet, the Internet, or any other group of processing systems communicatively connected to each other), and computer-readable medium 512.

In the depicted example, the aforementioned components are coupled by a bus 510, which may generally be configured for data or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of one or more central processing units (CPUs), graphics processing units (GPUs), tensor processing units (TPUs), accelerators, and other processing devices.

Input/output device(s) 504 may include any device, mechanism, system, interactive display, or various other hardware components for communicating information between processing system 500 and a user of processing system 500. For example, input/output device(s) 504 may include input hardware, such as a keyboard, touch screen, button, microphone, or other device for receiving inputs from the user. Input/output device(s) 504 may further include display hardware, such as, for example, a monitor, a video card, or other device for sending or presenting visual data to the user. In certain embodiments, input/output device(s) 504 is or includes a graphical user interface.

Display device(s) 506 may generally include any device configured to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, or extended reality devices.

Network interface(s) 508 provide processing system 500 access to external networks and processing systems. Network interface(s) 508 can generally be any device capable of transmitting or receiving data through a wired or wireless network connection. Accordingly, network interface(s) 508 can include a transceiver for sending or receiving wired or wireless communication. For example, Network interface(s) 508 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 508 includes hardware configured to operate in accordance with the Bluetooth® wireless communication protocol.

Computer-readable medium 512 may be a volatile memory, such as a random access memory (RAM), or a non-volatile memory, such as non-volatile random access memory, phase change random access memory, or the like. In this example, computer-readable medium 512 includes preprocessing logic 514, sampling logic 516, evaluation logic 518, and selection logic 520.

In certain embodiments, preprocessing logic 514 can process and prepare streaming data for optimal machine learning model evaluation and selection, for instance, by aggregating multiple streams into a single stream and removing duplicate data. The preprocess component 210 of FIG. 2 can perform the preprocessing logic 514.

In certain embodiments, sampling logic 516 can select a subset of data in accordance with a sampling frequency for further processing. The sampling logic 516 can be performed by the sampler component 220 of FIG. 2.

In certain embodiments, evaluation logic 518 can assess the performance of a machine learning model including accuracy. The evaluation logic 5186 can be performed by the evaluator component 240 of FIG. 2.

In certain embodiments, selection logic 520 can select a machine learning model for generating inferences based on evaluation results. The update component 250 of FIG. 2 can perform the selection logic 520.

Note that FIG. 5 is just one example of a processing system consistent with aspects described herein, and other processing systems having additional, alternative, or fewer components are possible consistent with this disclosure.

### Example Clauses

Implementation examples are described in the following numbered clauses:
Clause 1: A machine learning model evaluation and selection method, comprising: sampling streaming input in a streaming platform producing sampled input data, routing the sampled input data to two or more machine learning models, evaluating performance of each of the two or more machine learning models based on the sampled input data, identifying a select machine learning model from the two or more machine learning models based on the performance of each of the two or more machine learning models, and configuring the streaming platform to employ the select machine learning model for inferencing.
Clause 2: The method of Clause 1, further comprising continuously evaluating the performance of the two or more machine learning models while the streaming input is received.
Clause 3: The method of Clauses 1-2, further comprising determining that each of the two or more machine learning models is underperforming with respect to the sampled input data, and dynamically adjusting a sampling frequency to collect additional sampled input data.
Clause 4: The method of Clauses 1-3, further comprising triggering fine-tuning of one of the two or more machine learning models with the additional sampled data.
Clause 5: The method of Clauses 1-4, wherein evaluating the performance comprises comparing the performance of a first machine learning model of the two or more machine learning models to the performance of a second machine learning model of the two or more machine learning models, wherein the first machine learning model is a custom machine learning model and the second machine learning model is a general-purpose machine learning model.
Clause 6: The method of Clauses 1-5, further comprising: determining that a first machine learning model of the two or more machine learning models outperforms a second machine learning model of the two or more machine learning models by a threshold, and removing the second model after a predetermined time.
Clause 7: The method of Clauses 1-6, further comprising: receiving data from multiple streaming sources, removing duplicate data from the multiple streaming sources, and aggregating the multiple streaming sources into the streaming input.
Clause 8: The method of Clauses 1-7, wherein receiving data from the multiple streaming sources comprises receiving operational data regarding a deployed application.
Clause 9: The method of Clauses 1-8, wherein the two or more machine learning models are large language models trained to summarize the operational data.
Clause 10: A processing system, comprising: a memory comprising computer-executable instructions and a processor configured to execute the computer-executable instructions and cause the processing system to perform a method in accordance with any one of Clauses 1-9.
Clause 11: A processing system, comprising means for performing a method in accordance with any one of Clauses 1-9.
Clause 12: A non-transitory computer-readable medium storing program code for causing a processing system to perform the steps of any one of Clauses 1-9.
Clause 13: A computer program product embodied on a computer-readable storage medium comprising code for performing a method in accordance with any one of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various elements, steps, or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, method steps, and flow components described in the present disclosure may be implemented or performed with a general-purpose processor, a special-purpose processor (e.g., an artificial intelligence processor), combinations of general-purpose and special-purpose processors, and other programmable logic devices, or any combination thereof. A general-purpose processor may be a microprocessor, a commercially available processor, a controller, a microcontroller, or a state machine. A processor may also be implemented as a combination of computing devices.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, “real time” refers to processing with minimal and acceptable delay. The term emphasizes immediacy while recognizing that some level of latency exists in any system. The term practically targets a time frame imperceptible to a user or within the requirements of a particular application without requiring instantaneous or zero latency responses.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as one or more buses.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to general and special purpose processors.

The following claims are not intended to be limited to the aspects shown herein, but are to be accorded the full scope consistent with the language of the claims. Reference to an element in the singular is not intended to mean only one element unless specifically so stated, but rather “one or more” elements. The subsequent use of a definite article (e.g., “the” or “said”) with respect to an element (e.g., “the processor”) is not intended to limit the claim to an interpretation requiring only a single element (e.g., “only one processor”) unless otherwise specifically stated. For example, reference to an element (e.g., “a processor,” “a controller,” “a memory,” “the processor,” “the controller,” “the memory,”), unless otherwise specifically stated, should be understood to refer to one or more elements (e.g., “one or more processors,” “one or more controllers,” “one or more memories,”).

The terms “set” and “group” in the claims are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system, a processing system, or an apparatus) to perform functions, one element may be configured to cause the other element to perform all functions, or more than one element may collectively be configured to cause the other element to perform the functions.

Unless specifically stated otherwise, the term “some” refers to one or more.

All structural and functional equivalents to the elements of the various aspects described throughout this disclosure that are known or later become known to those of ordinary skill in the art are intended to be encompassed by the claims. Moreover, nothing disclosed herein is intended to be dedicated to the public, regardless of whether such disclosure is explicitly recited in the claims.

What is claimed is:

1. A machine learning model selection method, comprising:
sampling streaming input in a streaming platform producing sampled data;
routing the sampled data to two or more machine learning models;
evaluating performance of each of the two or more machine learning models based on the sampled data;
identifying a select machine learning model from the two or more machine learning models based on the performance of each of the two or more machine learning models; and
configuring the streaming platform to employ the select machine learning model for inferencing.

2. The method of claim 1, further comprising continuously evaluating the performance of the two or more machine learning models while the streaming input is received.

3. The method of claim 1, further comprising:
determining that each of the two or more machine learning models is underperforming with respect to the sampled data; and
dynamically adjusting a sampling frequency to collect additional sampled data.

4. The method of claim 3, further comprising triggering fine-tuning of one of the two or more machine learning models with the additional sampled data.

5. The method of claim 1, wherein evaluating the performance comprises comparing the performance of a first machine learning model of the two or more machine learning models to the performance of a second machine learning model of the two or more machine learning models, wherein the first machine learning model is a custom machine learning model and the second machine learning model is a general-purpose machine learning model.

6. The method of claim 1, further comprising:
determining that a first machine learning model of the two or more machine learning models outperforms a second machine learning model of the two or more machine learning models by a threshold; and
removing the second machine learning model after a predetermined time.

7. The method of claim 1, further comprising:
receiving data from multiple streaming sources;
removing duplicate data from the multiple streaming sources; and
aggregating the multiple streaming sources into the streaming input.

8. The method of claim 7, wherein receiving data from the multiple streaming sources comprises receiving operational data regarding a deployed application.

9. The method of claim 8, wherein the two or more machine learning models are large language models trained to summarize the operational data.

10. A system, comprising:
at least one processor; and
at least one memory coupled to the at least one processor that stores instructions, that when executed by the at least one processor, cause the system to:
sample streaming input in a streaming platform producing sampled data;
route the sampled data to two or more machine learning models;
evaluate performance of each of the two or more machine learning models based on the sampled data;
identify a select machine learning model from the two or more machine learning models based on performance based on the performance of each of the two or more machine learning models based on the performance of each of the two or more machine learning models; and
configure the streaming platform to employ the select machine learning model for inferencing.

11. The system of claim 10, wherein performance evaluation of each of the two or more machine learning models is continuous until the performance evaluation is terminated by the streaming platform.

12. The system of claim 10, wherein the instructions further cause the system to:
determining that each of the two or more machine learning models is underperforming with respect to the sampled data; and
dynamically adjusting a sampling frequency to collect additional sampled data.

13. The system of claim 12, wherein the instructions further cause the system to trigger fine-tuning of one of the two or more machine learning models with the additional sampled data.

14. The system of claim 10, wherein evaluate the performance comprises comparing the performance of a first machine learning model of the two or more machine learning models to the performance of a second machine learning model of the two or more machine learning models, wherein the first machine learning model is a custom machine learning model and the second machine learning model is a general-purpose machine learning model.

15. The system of claim 10, wherein the instructions further cause the system to:
determine that a first machine learning model outperforms a second machine learning model by a threshold; and
remove the second machine learning model after a predetermined time.

16. The system of claim 10, wherein the instructions further cause the system to
receiving data from multiple streaming sources;
remove duplicate data from the multiple streaming sources; and
aggregate deduplicated data from the multiple streaming sources into the streaming input.

17. The system of claim 16, wherein the data from the multiple streaming sources is operational data regarding a deployed application, and the two or more machine learning models are large language models trained to summarize the operational data.

18. A method, comprising:
receive operational data regarding a deployed application;
adding the operational data to an input stream;
sampling input stream at a sampling frequency to produce sampled input data;
routing the sampled input data to two or more large language models;
evaluating each of the two or more large language models;
identifying a select large language model from the two or more large language models based on performance of each large language model; and
configuring a streaming platform to employ the select large language model for inferencing.

19. The method of claim 18, saving output of at one model of the two or more large language models for subsequent retrieval and use to finetune another model of the two or more large language models.

20. The method of claim 19, further comprising:
detecting a rollback of the deployed application; and
invoking the select large language model to at least one of summarize operational data before the rollback or determine a root cause of the rollback.
